(19) United States
(12) Patent Application Publication
(10) Pub. No.: US 2022/0230511 A1
(43) Pub. Date: Jul. 21, 2022

(54) INFORMATION PROCESSING DEVICE

(71) Applicant: MIXI. INC., Tokyo (JP)

(72) Inventor: Jin FUJISAWA, Tokyo (JP)

(21) Appl. No.: 17/596,309

(22) PCT Filed: Jun. 8, 2020
(86) PCT No.: PCT/JP2020/022498

§ 371 Date: Dec. 7, 2021

(30) Foreign Application Priority Data
Jun. 10, 2019 (JP) 2019-107850

(51) Int. Cl. G07F 17/32

(52) U.S. Cl. CPC G07F 17/3288; G07F 17/3227

(57) ABSTRACT

An information processing device is provided that communicates with a user terminal and includes a manager, receiver, and result processor, wherein the manager associates a betting right by which a winning or losing prediction can be bet for and a betting right value with user identification information. The receiver receives, from the terminal, a betting instruction by the betting right associated with the user identification information and a holding instruction. The result processor maintains the betting right by taking the value, managed by the manager and associated with the betting right, as a value equal to or smaller than that before the bet when the instruction is the holding instruction, and associates a higher value than before the bet with the betting right based on the betting instruction to be managed by the manager as the betting right by which betting is possible, when the instruction is the betting instruction and the winning or losing prediction corresponding to the betting right has come true. When the prediction to the betting right is missing, the value associated with the betting right is deleted.

### CROSS REFERENCE TO RELATED APPLICATIONS

This application is a U.S. National Phase Application under 35 U.S.C. 371 of International Application No. PCT/JP2020/022498, filed on Jun. 8, 2020, which claims priority to Japanese Patent Application No. 2019-107850, filed on Jun. 10, 2019. The entire disclosures of the above applications are expressly incorporated by reference herein.

### BACKGROUND

### Technical Field

The present invention relates to an information processing apparatus.

### Related Art

Sports Promotion Lottery for soccer is well-known, and a lottery system has been proposed in which betting information can be easily specified (see Patent Application Publication No. 2018-136898).

By the way, in the betting described in Patent Application Publication No. 2018-136898 since it is necessary to predict results of a plurality of games, the betting content becomes complicated. Then, it will be difficult to increase the number of users if the betting content is complicated.

The present invention has been made in view of the above circumstances and provided an information processing apparatus capable of betting a win/lose prediction of a game more easily.

### SUMMARY

According to the present invention, provided is an information processing apparatus capable of communicating with a terminal of a user, comprising: a management unit configured to manage a betting right capable of betting a win/lose prediction of a predetermined team and a value of the betting right by associating with user identification information to identify a user; a reception unit configured to receive, from the terminal, a betting instruction to instruct betting by a betting right associated with the user identification information and one of a plurality of instructions including a pending instruction of the betting; and a result processing unit configured, when the received instruction is a pending instruction, to maintain the betting right in such a manner that a value associated with the betting right managed by the management unit is lower than or equal to a value before the betting and, when the received instruction is a betting instruction, to allow the management unit to manage a betting right based on the betting instruction as a betting right capable of betting by associating with a value higher than before the betting if the win/loss prediction of the team corresponding to the betting right is hit, and to allow the value associated with the betting right based on the betting instruction to disappear if the win/lose prediction of the team corresponding to the betting right is missed.

According to the information processing apparatus of the present invention, it is possible to bet a win/lose prediction of a game more easily.

### BRIEF DESCRIPTION OF THE DRAWINGS

FIG. 1 is a diagram showing a configuration of a system 100 including an information processing apparatus 1 according to an embodiment of the present invention.

FIG. 2 is a block diagram showing a functional configuration of the information processing apparatus 1.

FIG. 3 is an activity diagram showing a flow of betting from a perspective of a user.

FIG. 4 is an activity diagram showing a flow of an operation of the information processing apparatus 1.

FIG. 5 is a diagram showing an example of information managed by a management unit 101.

FIG. 6 is a diagram showing an example of information managed by the management unit 101.

FIG. 7 is a diagram showing an example of information managed by a management unit.

FIG. 8 is a diagram showing an example of information managed by a management unit.

### DETAILED DESCRIPTION

Hereinafter, embodiments of the present invention will be described with reference to the drawings. Various features described in the embodiment below can be combined with each other. Especially in the present specification, “unit” may include, for instance, a combination of hardware resources implemented by circuits in a broad sense and information processing of a software that can be concretely realized by these hardware resources. Further, although various information (program, each content, etc.) is performed in the present embodiment, this information can be represented by high and low signal values as a bit set of binary numbers configured of 0 or 1, and communication/calculation can be performed on a circuit in a broad sense.

Further, the circuit in a broad sense is a circuit realized by combining at least an appropriate number of a circuit, a circuitry, a processor, a memory, and the like. In other words, it is a circuit includes Application Specific Integrated Circuit (ASIC), Programmable Logic Device (e.g., Simple Programmable Logic Device (SPLD), Complex Programmable Logic Device (CPLD), and Field Programmable Gate Array (FPGA)), and the like.

### 1. Overall Configuration

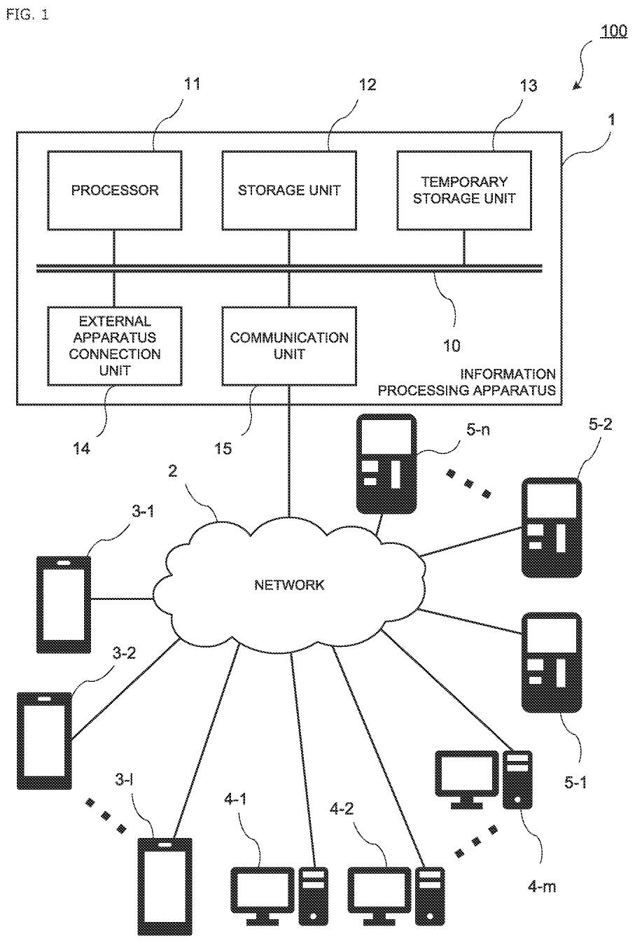

FIG. 1 is a diagram showing a configuration of a system 100 including an information processing apparatus 1 according to an embodiment of the present invention. As shown in the drawing, the system 100 comprises the information processing apparatus 1 and a plurality of terminals, that is, terminal 3-1 to terminal 3-l, terminal 4-1 to terminal 4-m, and terminal 5-1 to terminal 5-n. The information processing apparatus 1 can communicate with the terminal 3-1 to the terminal 3-l, the terminal 4-1 to the terminal 4-m, and the terminal 5-1 to the terminal 5-n via a network 2 such as internet, respectively.

As shown in the drawing, the information processing apparatus 1 comprises a processor 11, a storage unit 12, a temporary storage unit 13, an external apparatus connection unit 14, and a communication unit 15, and these components are electrically connected via a communication bus 10 inside the information processing apparatus 1.

The processor 11 is realized, for instance, by a central processing unit (CPU), and operates according to a predetermined program stored in the storage unit 12 to realize various functions.

The storage unit 12 is a non-volatile storage medium that stores various types of information. The storage unit 12 is realized, for instance, by a storage device such as a hard disk drive (HDD) or a solid state drive (SSD). The storage unit 12 can also be distributed in another apparatus capable of communicating with the information processing apparatus 1.

The temporary storage unit 13 is a volatile storage medium. The temporary storage unit 13 is realized, for instance, by a random access memory (RAM) or other memory, and stores temporarily necessary information (arguments, arrays, etc.) when the processor 11 operates.

The external apparatus connection unit 14 is a connection unit that conforms to standards such as universal serial bus (USB) or high-definition multimedia interface (HDMI), and can connect an input apparatus such as a keyboard or a display apparatus such as a monitor.

The communication unit 15 is a communication means that conforms to, for instance, local area network (LAN) standard, and realizes communication between the information processing apparatus 1 and the network 2.

As in the information processing apparatus 1, a computer or the like can be used for a general-purpose server, and it is possible to configure the information processing apparatus 1 by using a plurality of computers.

Further, the terminal 3-1 to the terminal 3-l are terminals having communication means such as smartphones or tablets, respectively, the terminal 4-1 to 4-m are terminals having communication means such as personal computers, and the terminal 5-1 to the terminal 5-n are terminals having communication means installed in stores or the like. Since these are general-purpose terminals, detailed description thereof will be omitted here.

### 2. Function of Information Processing Apparatus 1

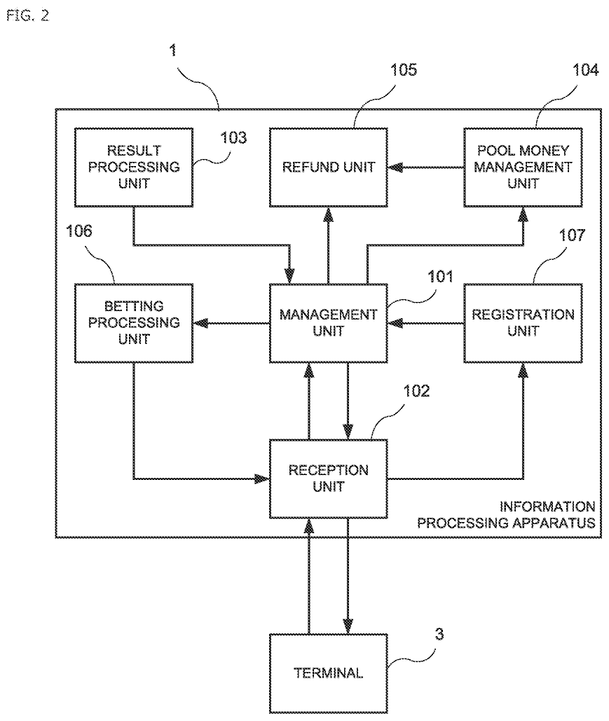

FIG. 2 is a block diagram showing a functional configuration of the information processing apparatus 1. The terminal 3 shown in the drawing is any of the terminal 3-1 to the terminal 3-l, the terminal 4-1 to the terminal 4-m, and the terminal 5-1 to the terminal 5-n shown in FIG. 1. Each portion of the information processing apparatus 1 shown in FIG. 2 is realized by the information processing device 1 executing a program.

As shown in the drawing, the information processing apparatus 1 comprises a management unit 101, a reception unit 102, a result processing unit 103, a pool money management unit 104, a refund unit 105, a betting processing unit 106, and a registration unit 107.

The management unit 101 is configured to manage a betting right capable of betting a win/lose prediction of a predetermined team and a value of the betting right by associating with user identification information to identify a user. The betting right is a right to cast a bet, and in principle, the user receives a transfer by paying a predetermined consideration, that is, a purchase, and the team to be bet is selected at the time of purchase.

The reception unit 102 is configured to receive, from the terminal 3, a betting instruction to instruct betting by a betting right associated with the user identification information and one of a plurality of instructions including a pending instruction of the betting. The plurality of instructions includes a refund request based on a value when the value associated with the betting right becomes equal to or greater than a threshold value. The threshold value is, for instance, twice the value at the time of purchase of the betting right. Further, although the reception unit 102 receives a win/lose prediction of a team corresponding to the betting right as a bet, only the win prediction of the team may be received as a betting instruction. In this case, the user may give a pending instruction instead of a betting instruction if the user predicts that the team will lose.

Further, when the betting instruction is an instruction of a first bet by a betting right, the reception unit 102 receives the betting instruction until a predetermined timing after a start of a game of a team corresponding to the betting right. On the other hand, when the betting instruction is an instruction for a second or subsequent bet by the betting right, the reception unit 102 receives the betting instruction prior to a deadline for receiving a first betting instruction, for example, until before the start of the game of the team corresponding to the betting right. Even when the betting instruction is a second or subsequent betting instruction, the reception unit 102 may receive the betting instruction until the predetermined time after the start of the game of the team corresponding to the betting right, as in the case of the first betting instruction.

When the instruction received by the reception unit 102 is a pending instruction, the result processing unit 103 maintains the betting right in such a manner that a value associated with the betting right managed by the management unit 101 is lower than or equal to a value before the betting. On the other hand, when the instruction received by the reception unit 102 is a betting instruction, the result processing unit 103 allows the management unit 101 to manage a betting right based on the betting instruction as a betting right capable of betting by associating with a value higher than before the betting if the win/loss prediction of the team corresponding to the betting right is hit, and allows the value associated with the betting right based on the betting instruction to disappear if the win/lose prediction of the team corresponding to the betting right is missed. When the value disappears, the result processing unit 103 also allow the betting right itself to disappear, thus the user cannot cast a bet using the betting right next time. when the instruction received by the reception unit 102 is a betting instruction, the result processing unit 103 maintains a betting right in such a manner that the value associated with the betting right managed by the management unit 101 is lower than or equal to the value before the betting if the game of the team corresponding to the betting right is a draw. In both the case where the game is a draw and the case where there is a pending instruction, although the result processing unit 103 maintains the betting right in such a manner that the value associated with the betting right is lower than or equal to the value before the betting, the value to be maintained may be the same or different in both cases.

The pool money management unit 104 manages a pool money. The pool money is a source of a fund when performing a refund based on the value associated with the betting right, and is allocated as a part of a transfer consideration (sales amount) of the betting right. For instance, when a betting right disappears by the result processing unit 103, a predetermined percentage of the transfer consideration of the betting right, such as an amount multiplied by a factor greater than 0 and less than 1, is added to the pool money. In addition, a predetermined percentage of the transfer consideration of the betting right after the result of the game immediately after the sale of the betting right is confirmed, rather than the transfer consideration of the betting right disappears by the result processing unit 103, may be added to the pool money.

The pool money management unit 104 may manage the transfer consideration of the betting rights for each team individually as a pool money, or may manage the transfer consideration of the betting rights for a plurality of teams collectively as a pool money. When managing the transfer consideration of the betting rights of the plurality of teams as a pool money, it may be managed collectively for each group, for instance, for each league, or the transfer consideration of the betting rights of all teams may be collectively managed as a pool money.

The refund unit 105 determines a refund amount according to a total number of values associated with betting rights managed by the management unit 101 and a unit value determined based on the pool money managed by the pool money management unit 104. The unit value is, for instance, a value obtained by dividing the pool money by the total number of values. The refund amount is a product of the unit value and the value associated with the betting right to be refunded.

Therefore, the unit value will be the same amount for the betting rights of all teams at the same time point if the pool money management unit 104 manages the transfer consideration for the betting rights of all teams collectively as pool money, however, the amount of the unit value will be different for the betting right of each team even at the same time point.

Information such as the amount of the refund determined by the refund unit 105 may be displayed on a terminal 3. The information to be displayed on the terminal 3 is, for instance, a total amount of the pool money, an amount of the unit value, and an amount of the refund for each betting right at the time point the information is displayed. In addition, the terminal 3 may be allowed to display information regarding the betting rights of any user whose ranking based on the size of the value is within a predetermined value, or a total value of the betting rights of each team.

The betting processing unit 106 bets for a victory of a team corresponding to the betting right if the reception unit 102 has not received any of a plurality of instructions including the betting instruction and the pending instruction when a pre-specified condition is satisfied, for instance, when a condition such as reaching the start time of the game is satisfied. Then, the reception unit 102 receives the bet by the betting processing unit 106 as a betting instruction. In other words, the betting processing unit 106 automatically bets for win for the betting right that has not received any instruction when the pre-specified condition is satisfied. The pre-specified condition may be set to reach a deadline for the reception unit 102 to receive the betting instruction.

In addition, the betting processing unit 106 does not automatically bet for win, but processes the betting right that has not received any instruction in the same manner as the previous time when the pre-specified condition is satisfied, i.e., may give a pending instruction for the betting right that has received the pending instruction last time, and may give a betting instruction for win to the betting right that has received the betting instruction for win last time. Further, it is also possible to specify in advance the processing when the user does not give any instruction.

The registration unit 107 receives an input of betting right identification information in which a betting content is set from the terminal 3, when a win/lose prediction of a team corresponding to a betting right identified by the received betting right identification information is hit, associates the betting right with a higher value than a value of a time of inputting the betting right identification information and with the user identification information, and allows the management unit to manage the betting right as a betting right capable of betting. The betting right identification information is, for instance, a serial code printed on a face of a betting ticket sold at a game venue or a predetermined store. The serial code includes a serial number and a check digit calculated from the serial number, thus it is difficult to analogize the serial code.

### 3. Flow of Betting

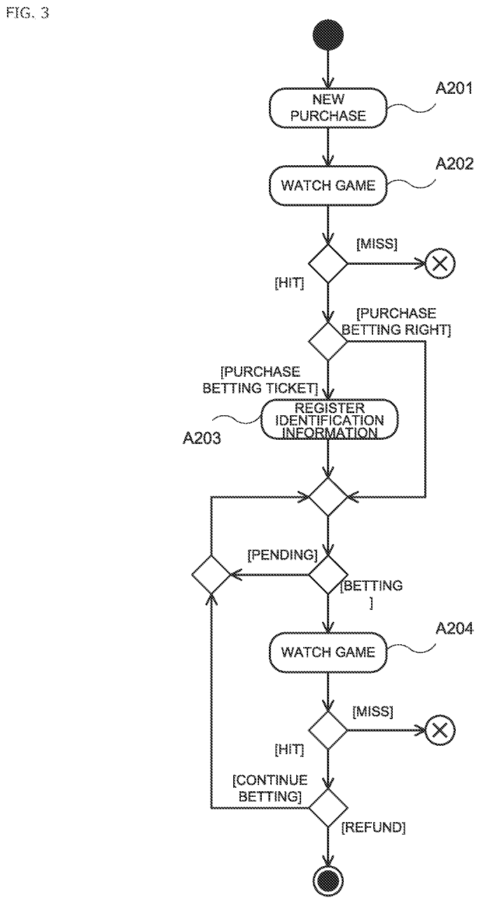

Next, a flow of betting using the information processing apparatus 1 will be described from a perspective of the user. FIG. 3 is an activity diagram showing the flow of betting from the perspective of the user.

The user first purchases a new betting right (A201). To purchase the betting right, the user accesses a site identified by a predetermined URL

(Uniform Resource Locator) from terminal 3, and purchases through an authentication processing or the like. The URL can be posted in various locations. For instance, it may be displayed as a poster with a two-dimensional barcode representing the URL printed thereon at a game venue or may be announced in various other ways. The betting right may be sold at a stall such as a game venue as a betting ticket with betting right identification information printed thereon.

There are two types of betting, one that allows the user to bet for either win or lose of a predetermined team, and one that only allows the user to bet for win of a predetermined team, and either or both of which are provided. In the case of the type that allows the user to bet for either win or lose of the predetermined team, the user chooses either win or lose, and in the case of the type that only allows the user to bet for win of the predetermined team, the user purchases a bet only if the user predicts win of the predetermined team.

The betting right can be purchased until a predetermined time before or after the start of the game, such as until the end of the third inning if the game is baseball.

Once purchasing the betting right, the user can watch the game (A202).

The game may be watched at the game venue or through media such as television. Not that watching the game is not essential for the user.

Regarding the result of the game, when the prediction of the user is missed, the betting right purchased in A201 disappears (invalids), and the betting by the betting right will be terminated. If the user wishes to bet in the next game, he/she needs to purchase a betting right again.

On the other hand, if the prediction of the user is hit, the user can bet in the next game as well. When the betting right is purchased with a betting ticket, the user accesses a site specified by the predetermined URL using the terminal 3, and registers a serial code that is an example of the betting right identification information printed on the betting ticket (A203). By registering the betting right identification information, the user can bet from the terminal 3 in the next game. Furthermore, the user who has purchased the betting right from the terminal 3 will wait until the reception of betting for the next game begins.

Thereafter, when the reception of betting for the next game begins, the user can either give a bet instruction or a pending instruction to the information processing apparatus 1 via the terminal 3. In the case of a type in which the betting is available only for win of a predetermined team, the user gives a betting instruction when predicting win of the predetermined team, and gives a pending instruction when predicting loss of the predetermined team. In other words, when purchasing a plurality of betting rights, the user can give a betting instruction or a pending instruction for each betting right. The user can also purchase a new betting right at this timing.

Once giving a betting instruction, the user can watch the game (A204). The game may be watched at the game venue or through media such as television. Not that watching the game is not essential for the user.

Regarding the result of the game, when the prediction of the user is missed, the betting right purchased in A201 disappears (invalids), and the betting by the betting right will be terminated.

On the other hand, if the prediction of the user is hit, the user can bet in the next game as well. If the prediction of the user is hit more than a predetermined number of times, for instance, more than twice, then the user can request a refund of the corresponding betting right. When requesting a refund, the user gives a refund instruction to the information processing apparatus 1 via the terminal 3. When the refund instruction is given, the betting right purchased in A201 disappears (invalids), and the betting by the betting right will be terminated. The period during which the user can request a refund is a predetermined period, for instance, a period during which betting is possible. If the refund instruction is not given, the user waits until the reception of betting for the next game begins, and then repeats the same processing. The refund instructions can be given for each betting right.

### 4. Operation of Information Processing Apparatus 1

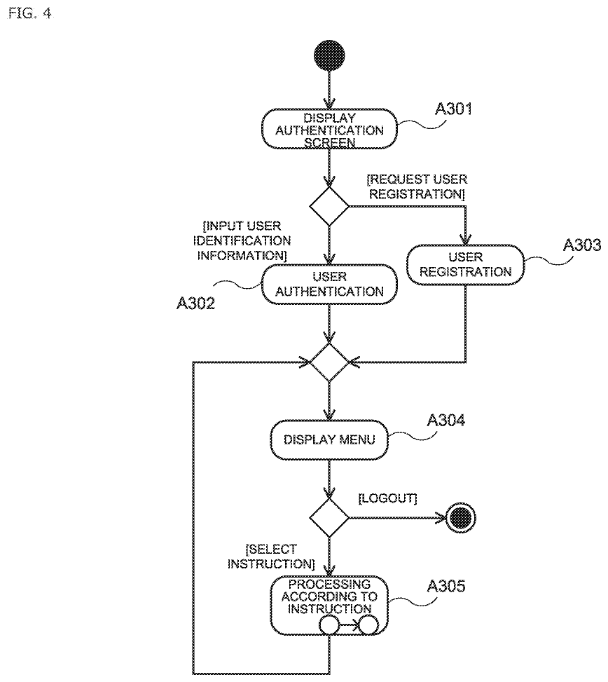

Next, a flow of an operation of the information processing apparatus 1 will be described. FIG. 4 is an activity diagram showing the flow of the operation of the information processing apparatus 1.

When the information processing apparatus 1 is accessed from the terminal 3, the reception unit 102 display an authentication screen on the terminal 3 (A301). On the authentication screen, user identification information can be input, and a link to a user registration screen for a user who do not have the user identification information is also displayed.

When the user identification information is input into the terminal 3 to the authentication screen, the reception unit 102 performs authentication processing of the user (A302). On the other hand, when the link to the user registration screen is selected from the terminal 3, the reception unit 102 displays the user registration screen on the terminal 3 and prompts the user to input necessary information and register as a user (A303).

After completing user authentication or user registration, the reception unit 102 displays a menu screen on the terminal 3 (A304). The menu screen displays items to instruct sale of betting right, registration of betting ticket, betting, pending, and refund, respectively, as well as items to instruct confirmation and modification of membership information, and items to instruct logout.

When an instruction item other than logout instruction is selected, the reception unit 102 executes processing according to the instruction (A305), and the processing is terminated when the logout instruction is selected.

### 4-1. Sales of Betting Right

When the sale of betting right is selected from the menu screen, the reception unit 102 displays a sales screen of betting right on the terminal 3. On the sales screen, the user can select a team to be bet for, the number of betting rights to be purchased, and the payment method. Based on information input into the menu screen, the reception unit 102 allows the management unit 101 to manage information of the sold betting right with a condition that the payment has been confirmed. If the payment method is bank transfer or the like which takes time to confirm the payment, then the information may be managed by the management section 101 as a provisional registration. When the betting right is not sold, the sale of betting right cannot be selected from the menu screen.

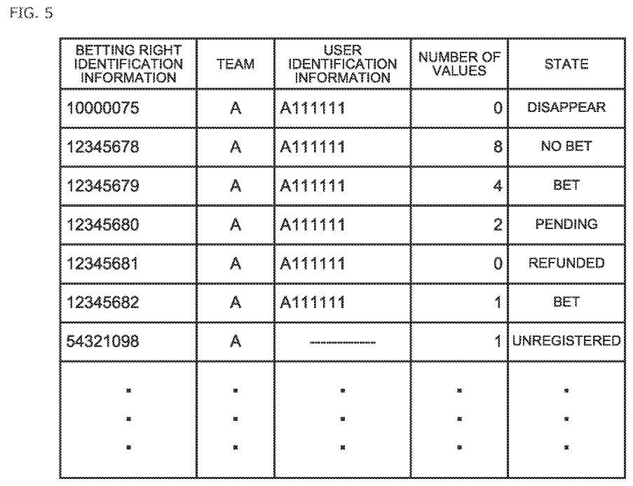

FIG. 5 is a diagram showing an example of information managed by a management unit 101. As shown in the drawing, the management unit 101 manages each betting right. For instance, even when multiple betting rights are purchased at once, the management is performed for each betting right. Specifically, the betting right identification information is managed by associating with team, user identification information, number of values, state, or the like. The betting right identification information is unique information for identifying a betting right. The team is information indicating the team corresponding to the betting right. The user identification information is information identifying the user who is an owner of the betting right. The user identification information is blank when the betting right is sold as a betting ticket and is unregistered. The number of values indicates the value corresponding to the betting right, and is set in such a manner that the number of values for each hit bet is greater than the number of values at the time of selling the betting right. For instance, the number of values is “1” at the time of selling the betting right, then may be multiplied for each hit bet by a predetermined number of times, for example, by twice. The state indicates a state of the betting right, and indicates each state such as “unbet,” “bet,” “pending,” “refunded,” “disappear,” “unregistered,” or the like. In the case of the type in which the betting is available for either win or lose of a predetermined team, “bet for win” or “bet for lose” is used instead of “bet”.

Even if the betting right disappeared, the management unit 101 manages the state of the betting right as “disappear” because it may be necessary when displaying the purchase history or the like of the user on the terminal 3 or calculating the pool money. When using information whose state is “disappear” in the calculation of the pool money, for example, the betting right before being counted in the pool money records the value immediately before the extinction of the betting right, and the value of the betting right after being counted in the pool money becomes 0. Depending on the calculation method of the pool money, it is possible to exclude the betting right whose state is “disappear” from the management of the management unit 101.

By the way, since the information shown in FIG. 5 assumes that the sales amount of one unit of the betting right is a fixed amount, each betting right identified by the betting right identification information is sold at the fixed amount, the management of the sales amount can be omitted. However, the betting right sold as a betting ticket will not be registered if the prediction is missed, thus it is necessary to manage the sales separately. If the sales amount of one betting right is not a fixed amount, it is necessary to manage the sales amount.

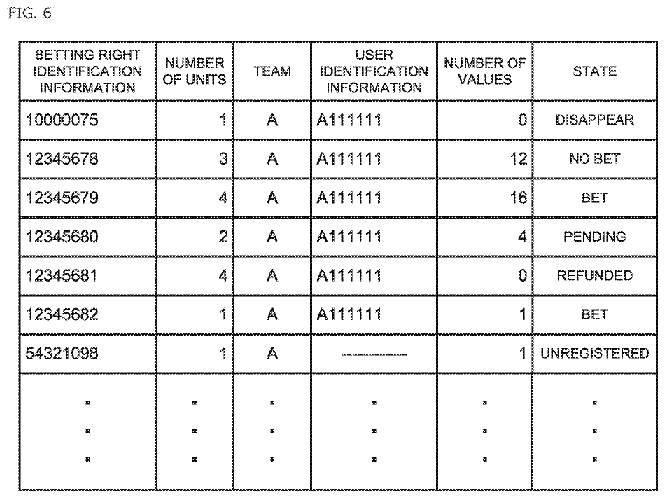

The management unit 101 may also manage a plurality of betting rights sold at the same time together. FIG. 6 is a diagram showing an example of the information managed by the management unit 101. As shown in the drawing, when managing the plurality of betting rights sold at the same time together, the management unit 101 manages the “number of units” of the betting rights in addition to the management content shown in FIG. 5. Even when managed in this way, for instance, among the betting rights in which the betting right identification information is “12345678”, by changing the betting right identification information of the bet betting right to “12345678-1,” and the betting right identification information of the pended betting right to “12345678-2”, it is possible to manage the plurality of betting rights even if some of them are bet and some others are pended. In addition, the management unit 101 may manage a plurality of betting rights that have the same user identification information and correspond to a predetermined game together.

By the way, since the information shown in FIG. 6 assumes that the sales amount of one unit of the betting right is a fixed amount, each betting right identified by the betting right identification information is sold at an amount that is the fixed amount multiplied by the number of units, the management of the sales amount can be omitted. However, the betting right sold as a betting ticket will not be registered if the prediction is missed, thus it is necessary to manage the sales separately. If the sales amount of one betting right is not the fixed amount, it is necessary to manage the sales amount.

### 4-2. Registration of Betting Ticket

When a registration of a betting ticket is selected from the menu screen, the reception unit 102 displays a screen on the terminal 3 that allows the user to input a serial code printed on a face of the betting ticket. When the serial code is input into the screen, the reception unit 102 passes the input serial code to the registration unit 107, and the registration unit 107 authenticates the serial code and, if it is correct, registers the user to the corresponding betting right. As a result, the management unit 101 changes the state of “unregistered” to “unbet”.

### 4-3. Betting

When betting is selected from the menu screen, the reception unit 102 displays a list of betting rights capable of betting on the terminal 3. Then, the betting is casted by the betting right selected by the terminal 3. As a result, the state of “unbet” is changed to any one of “bet”, “bet for win”, or “bet for lose” in the management unit 101.

### 4-4. Pending

When betting is selected from the menu screen, the reception unit 102 displays a list of betting rights capable of pending on the terminal 3. Then, the betting right selected by the terminal 3 is pended. As a result, the state of “unbet” is changed to “pending” in the management unit 101.

### 4-5. Refund

When refund is selected from the menu screen, the reception unit 102 displays a list of betting rights capable of refunding on the terminal 3. Then, the betting right selected from the terminal 3 is subject to refund, and a refund amount calculated by the refund unit 105 is transferred to the user. As a result, the state of “unbet” is changed to “refunded” in the management unit 101.

### 4-6. Automatic Betting (Automatic Pending)

When a pre-specified condition is satisfied, the betting processing unit 106 allows the reception unit 102 to bet for the betting right whose state is “unbet” among the betting rights managed by the management unit 101. As a result, the state of “unbet” is changed to “bet” in the management unit 101. As described above, the unbet betting right may be pended.

### 4-7. Result Processing

Further, when a result of a game is confirmed, among the betting rights managed by the management unit 101, the result processing unit 103 increases the number of values of the betting rights managed by the management unit 101 whose status is “bet” or the like and whose prediction is hit. On the other hand, the betting right whose prediction is missed is deleted. Then, the pool money management unit 104 adds a predetermined percentage of the transfer consideration of the betting right that disappeared to the pool money. As described above, instead of the transfer consideration of the betting right that disappeared, the predetermined percentage of the transfer consideration of the betting right sold in the game may be added to the pool money after the result of the game is confirmed immediately after the betting rights are sold.

### 5. Modifications

In the above description, although the case where the value is associated with the betting right is described, the number of betting rights may be increased when a prediction is hit without using the value, for example, doubling the number of units of the betting rights that the prediction is hit.

In this case, the information processing apparatus comprises a management unit, a reception unit, and a result processing unit, similarly to the information processing apparatus 1 described above.

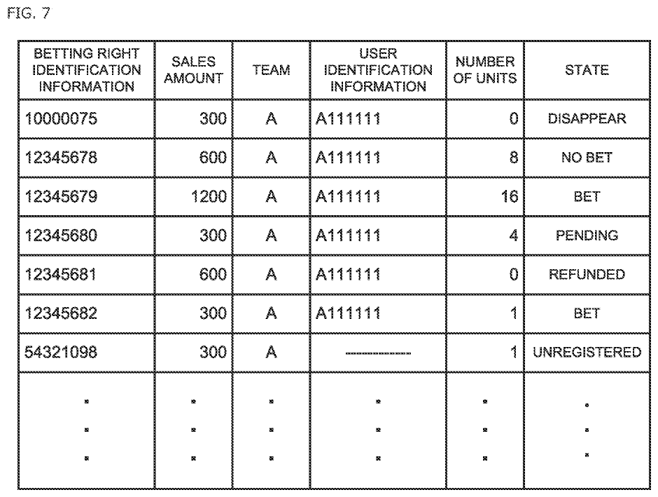

Unlike the management unit 101, the management unit also manages number of units of betting rights. FIG. 7 is a diagram showing an example of information managed by the management unit. As shown in the drawing, the management unit manages “number of units” of the betting rights. Since a value is not associated with the betting right, a management thereof is not performed. In addition, to perform accounting to a pool money, the management unit manages betting right identification information by associating with a sales amount. Even if a plurality of betting rights are sold together when selling the betting right, the management of the sales amount can be omitted if the betting right identification information is assigned to each betting right.

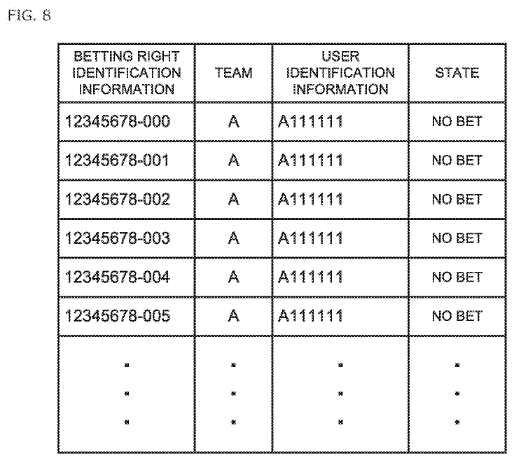

Furthermore, the management unit can also manage information in a form as shown in FIG. 8. FIG. 8 is a diagram showing an example of information managed by the management unit. In the example shown in the drawing, betting right identification information is assigned to each betting right. All betting rights to which the betting right identification information is assigned are one unit. In addition, among the betting right identification information, for instance, only the betting right ending in “000” is sold, and other betting right is managed as a betting right that a user has won due to hit prediction, both “number of units” and “sales amount” can be omitted.

The reception unit operates in the same way as the reception unit 102.

On the other hand, when a received instruction is a pending instruction, the result processing unit operates, when the received instruction is a pending instruction, to maintain a betting right managed by the management unit, and when the received instruction is a betting instruction, to allow the management unit to manage a plurality of betting rights as betting rights capable of betting by adding a new betting right to the betting rights if the win/loss prediction of the team corresponding to the betting right is hit, and to allow the betting instruction to disappear if the win/lose prediction of the team corresponding to the betting right is missed.

In the case of this modification, when a user initially purchases one betting right, each time a prediction hits, for instance, the number of betting rights increases to two, four, or eight, then the user can refund part of it and continue betting with another part.

1. An information processing apparatus configured to communicate with a terminal of a user, the information processing apparatus comprising:
a memory configured to store a program; and
a processor configured to execute the program so as to:
manage a betting right for betting a win/lose prediction of a predetermined team and a value of the betting right by associating with user identification information to identify a user;
receive, from the terminal, a betting instruction to instruct the betting by the betting right associated with the user identification information and one of a plurality of instructions including a pending instruction of the betting;
maintain the betting right in such a manner that the value associated with the betting right is lower than or equal to a value before the betting when the received instruction is the pending instruction;
allow to manage the betting right based on the betting instruction as the betting right for betting by associating with a higher value than before the betting if the win/loss prediction of the team corresponding to the betting right is hit when the received instruction is the betting instruction; and
allow the value associated with the betting right based on the betting instruction to disappear if the win/lose prediction of the team corresponding to the betting right is missed when the received instruction is the betting instruction.

2. The information processing apparatus according to claim 1,
wherein the processor is configured to receive a plurality of betting instructions with respect to a plurality of betting rights having values,
the processor is configured to manage a pool money and to add a predetermined percentage of a transfer consideration of the betting right to the pool money, and
the processor is configured to determine a refund amount according to a total number of the values associated with the plurality of betting rights and a unit value determined based on the pool money.

3. The information processing apparatus according to claim 1, wherein:
the processor is configured to bet for a victory of the team corresponding to the betting right if the processor has not received any of the plurality of instructions including the betting instruction and the pending instruction when a pre-specified condition is satisfied.

4. The information processing apparatus according to claim 1, wherein:
the processor is configured to continue a previous instruction with respect to the betting right if the processor has not received any of the plurality of instructions including the betting instruction and the pending instruction when the pre-specified condition is satisfied.

5. The information processing apparatus according to claim 1, wherein:
the processor is configured to receive a refund request based on the value when the value associated with the betting right becomes equal to or greater than a threshold value.

6. The information processing apparatus according to claim 1, wherein:
the processor is configured
to receive the betting instruction until a predetermined timing after a start of a game of the team corresponding to the betting right when the betting instruction is an instruction of a first bet by the betting right, and
to receive the betting instruction until before the timing when the betting instruction is an instruction for a second or subsequent bet by the betting right.

7. The information processing apparatus according to claim 1, wherein:
the processor is configured to receive a victory prediction of the team corresponding to the betting right as the betting instruction.

8. The information processing apparatus according to claim 1, wherein:
when the received instruction is the betting instruction, the processor is configured to maintain the betting right in such a manner that the value associated with the betting right is lower than or equal to a value before the betting if a game of a team corresponding to the betting right is a draw.

9. The information processing apparatus according to claim 1, wherein:
the processor is configured
to receive an input of betting right identification information in which a betting content is set from the terminal,
when the win/lose prediction of the team corresponding to the betting right identified by the received betting right identification information is hit,
to associate the betting right with a higher value than the value of a time of inputting the betting right identification information and with the user identification information, and
to allow to manage the betting right as a betting right capable of betting.

10. (canceled)

11. An information processing method configured to communicate with a terminal of a user, the information processing method comprising:
a managing step of managing a betting right for betting a win/lose prediction of a predetermined team and a value of the betting right by associating with user identification information to identify a user;
a receiving step of receiving, from the terminal, a betting instruction to instruct the betting by the betting right associated with the user identification information and one of a plurality of instructions including a pending instruction of the betting;
a result managing step of:
maintaining the betting right in such a manner that the value associated with the betting right is lower than or equal to a value before the betting when the received instruction is the pending instruction;
allowing to manage the betting right based on the betting instruction as the betting right for betting by associating with a higher value than before the betting if the win/loss prediction of the team corresponding to the betting right is hit when the received instruction is the betting instruction; and
allowing the value associated with the betting right based on the betting instruction to disappear if the win/lose prediction of the team corresponding to the betting right is missed when the received instruction is the betting instruction.

12. A non-transitory computer readable media storing a program, wherein:
the program allows a computer to function as an information processing apparatus configured to communicate with a terminal of a user, so as to:
manage a betting right for betting a win/lose prediction of a predetermined team and a value of the betting right by associating with user identification information to identify a user;
receive, from the terminal, a betting instruction to instruct the betting by the betting right associated with the user identification information and one of a plurality of instructions including a pending instruction of the betting;
maintain the betting right in such a manner that the value associated with the betting right is lower than or equal to a value before the betting when the received instruction is the pending instruction;
allow to manage the betting right based on the betting instruction as the betting right for betting by associating with a higher value than before the betting if the win/loss prediction of the team corresponding to the betting right is hit when the received instruction is the betting instruction; and
allow the value associated with the betting right based on the betting instruction to disappear if the win/lose prediction of the team corresponding to the betting right is missed when the received instruction is the betting instruction.
